(19) United States
(12) Patent Application Publication
(10) Pub. No.: US 2007/0113796 A1
(43) Pub. Date: May 24, 2007

(54) PET CHEW WITH NUTRACEUTICAL AGENT

(75) Inventors: Dan Schildgen, Fort Worth, TX (US); Isaac Mendal, Deerfield Beach, FL (US); Gary Hingst, Richmond, VA (US)

Correspondence Address: MCGARRY BAIR PC, 171 MONROE AVENUE, N.W., SUITE 600, GRAND RAPIDS, MI, 49503, US

(73) Assignees: SALIX L.L.C., Deerfield Beach, FL (US); VET SOLUTIONS L.P., Fort Worth, TX (US)

(21) Appl. No.: 11/561,992

(22) Filed: Nov. 21, 2006

Related U.S. Application Data
(60) Provisional application No. 60/597,327, filed on Nov. 23, 2005.

(51) Int. Cl. A01K 29/00

(52) U.S. Cl. 119/709

(57) ABSTRACT

A pet chew comprises one or more nutraceutical agent(s) that includes fish oil. The one or more nutraceutical agent(s) can be formulated to impart a health benefit to a pet. The pet chew can be comprised of rawhide or a hypoallergenic substance. The pet chew can be manufactured by extrusion.

### CROSS-REFERENCE TO RALATED APPLICATIONS

This application claims the benefit of U.S. Patent Application Ser. No. 60/597,327, filed Nov. 23, 2005, which is incorporated herein by reference in its entirety.

### BACKGROUND OF THE INVENTION

1. Field of the Invention

The present invention relates to pet chews. In one of its aspects, the invention relates to a rawhide pet chew incorporating one or more nutraceutical agent(s). In another of its aspects, the invention relates to a hypoallergenic pet chew incorporating one or more nutraceutical agent(s).

2. Description of the Related Art

Pet chews are commonly given to domestic animals such as dogs to satisfy the animal's need to chew. Tough edible substances such as rawhide are frequently used as dogs enjoy chewing on them. Rawhide is a by-product of the slaughter of hoofed animals and consists of the hide of the animal. Pet chews can be manufactured from rawhide by utilizing rawhide scraps left over from the manufacture of various other products made from hoofed animals, for example, cattle and swine. The rawhide can be subjected to a nonmechanical manufacturing method or a mechanical manufacturing method such as extrusion. In addition to rawhide, the pet chews can contain other ingredients such as fillers, binders, flavorings, colorants, and other additives.

Nutraceutical products are currently available in the veterinary market place for use in the treatment or management of acute or chronic conditions in animals. For example, nutraceutical products are used to manage canine afflictions such as atopic dermatitis, dermatitis secondary to flea allergies and degenerative joint disease or osteoarthritis. Examples of nutraceutical products for the management of atopic dermatitis are available in soft gelatin capsule and liquid form and contain nutraceutical agents that reduce the inflammation and pruritis associated with atopic dermatitis. Examples of nutraceutical products for the management of osteoarthritis are available in capsules, chewable tablets, and soft chewable forms and contain nutraceutical agents that manage that various conditions associated with degenerative joint disease. It is sometimes difficult to give an uncooperative animal capsules without some extraordinary procedures.

### SUMMARY OF THE INVENTION

A pet chew according to the invention comprises a tough, chewable substrate in a form that is adapted to be chewed or ingested by a domestic animal combined with an effective amount of a nutraceutical agent that includes fish oil.

According to one aspect of the invention, the fish oil can be present in an amount ranging from 1 to 10% by weight of the pet chew. The fish oil can be present in an amount ranging from 4% to 5% by weight of the pet chew. The fish oil can comprise 4.5% by weight of the pet chew.

According to another aspect of the invention, the pet chew can further comprise a second nutraceutical agent. The second nutraceutical agent can be selected from the group consisting of glucosamine hydrochloride, glucosamine sulfate, glucosamine potassium, glucosamine sodium, N-acetyl d-glucosamine, methyl sulfonlymethane (MSM), dimethyl sulfoxide (DMSO), chondroitin, perna canaliculus or green lipped mussel (New Zealand Green Lipped mussel), creatine, omega-3 fatty acids derived from marine sources, vitamin C, vitamin D, vitamin E, vitamin K, Alpha Lipoic Acid, grape seed extract, grape seed meal, dimethyl glycine, whey protein, manganese, manganese proteinate, zinc, zinc proteinate, copper, copper proteinate, brewer's yeast, St. John's wort, ginseng, green tea, ginger, garlic, vincamine, vinpocetine, aloe vera, ginko biloba and any combination thereof. The second nutraceutical agent can be present in an amount ranging from 0 to 20% by weight of the pet chew. The amount of glucosamine, if present, can range from 2 to 7% by weight of the pet chew; the amount of chondroitin, if present, ranges from 3 to 9% by weight of the pet chew; the amount of methylsulfonyl methane, if present, can range from 2 to 7% by weight of the pet chew; the amount of creatine, if present, can range from 1 to 4% by weight of the pet chew; and the amount of perna canaliculus, if present, can range from 0.5 to 3% by weight of the pet chew.

According to yet another aspect of the invention, the pet chew can further comprise glucosamine, methylsulfonyl methane, creatine, and perna canaliculus as nutraceutical agents.

According to still another aspect of the invention, the substrate can comprise rawhide. The substrate can comprise at least 50% rawhide by weight of the pet chew.

In another aspect of the invention, the pet chew can be free of meat, wheat, and dairy products. The substrate can be hypoallergenic. The substrate can comprise at least one of rice and soy. The rice and soy can be in the form of flour. The substrate can comprise both rice flour and soy flour. The substrate can comprise at least 50% of the at least one of rice and soy by weight of the pet chew.

In yet another aspect of the invention, the pet chew can be formed by extrusion. The substrate material can be comminuted into small particles, mixed with the fish oil and a binder, and then extruded into a form suitable for chewing by a domestic animal. The fish oil can be present on the substrate in the form of a coating.

In still another aspect of the invention, the pet chew can further comprise at least one of a flavoring, binder, filler, coloring, moisture retainer, mold inhibitor, nutritional supplement, vitamin, and any combination thereof.

### DESCRIPTION OF THE PREFERRED EMBODIMENT

According to the present invention, a pet chew is comprised of tough, chewable substrate and at least one nutraceutical agent present in an effective amount. As used herein, the term “nutraceutical” refers to a natural compound that is thought to promote health, and may help in the management of symptoms of some diseases. The term “effective amount” is used herein to refer to an amount or concentration of nutraceutical agent that will promote health in a domestic animal or result in the management of a symptom of a disease. The preferred nutraceutical agent is fish oil. Examples of other suitable nutraceutical agents include, but are not limited to eicosapentaenoic acid (EPA), docosahexaenoic acid (DHA), glucosamine hydrochloride, glucosamine sulfate, glucosamine potassium, glucosamine sodium, N-acetyl d-glucosamine, methyl sulfonlymethane (MSM), dimethyl sulfoxide (DMSO), chondroitin, perna canaliculus or green lipped mussel (New Zealand Green Lipped mussel), creatine, omega-3 fatty acids derived from marine sources (such as, but not limited to, marine algae, mussels, and other shellfish), vitamin C, vitamin D, vitamin E, vitamin K, Alpha Lipoic Acid, grape seed extract, grape seed meal, dimethyl glycine, whey protein, manganese, manganese proteinate, zinc, zinc proteinate, copper, copper proteinate, brewer's yeast, St. John's wort, ginseng, green tea, ginger, garlic, vincamine, vinpocetine, aloe vera, and ginko biloba. The pet chew can also comprise a number of different nutraceutical agents to manage various symptoms of a single disease or multiple diseases.

The pet chew can further comprise other additives that enhance the flavor, manufacturability, appearance, and/or appeal of the pet chew. Examples of additives are flavorings, binders, fillers, colorings, moisture retainers, mold inhibitors, antioxidants, or any combination thereof. Examples of flavorings include beef, chicken, ground pig hide, fishmeal, chocolate, garlic, liver, onion powder, and other animal- or plant-based additives. Examples of binders include starches, such as potato starch, flours, such as wheat flour, grains, gelatin, and collagen protein. An example of a moisture retainer is polypropylene glycol. An example of a mold inhibitor is potassium sorbate. Examples of antioxidants include soybean oil, canola oil, tocopherols (Vitamin E), and citric acid.

The pet chew can be produced using any suitable manufacturing method, including both non-mechanical and mechanical methods. An exemplary nonmechnical method of manufacturing the pet chew comprises basting a hardened chew substrate with a nutraceutical-containing slurry. The specific method of basting a pet chew with a slurry is known and thus will only be generally described. An example of such a method is taught in U.S. Pat. No. 6,840,196, which is incorporated herein by reference in its entirety. The substrate can be rawhide that is prepared by cutting and rolling rawhide scraps into a desired shape, such as a rope or strip. During the rolling step, the rawhide can be substantially dry or wet. The rawhide strips are then dried until they are hard and bonelike. Once the rawhide strips are dry, the outside of the chew is coated with the slurry and allowed to dry once again. The slurry comprises at least one nutraceutical agent. The nutraceutical agent is preferably fish oil. The slurry can optionally also comprise one or more other common additives, such as water, salt, flavoring, coloring, moisture retainers, mold inhibitors, antioxidants, or any combination thereof.

A preferred mechanical method of manufacturing the pet chew is extrusion. The specific method of extrusion is not germane to the invention and thus will only be generally described. An example of a suitable extrusion method for a pet chew made substantially of rawhide is taught in U.S. Pat. No. 4,702,929, which is incorporated herein by reference in its entirety. Briefly, wet rawhide scraps are dried and ground or comminuted into smaller pieces. The rawhide is preferably mixed with one or more nutraceutical agent(s) and preferably also with a binder to form a homogeneous mixture. Other additives can also be added to the rawhide mixture at this point. The rawhide mixture is then fed into an extruder having multiple heating zones set up sequentially along the path of extrusion and then through a die. The extruded rawhide mixture is cooled and formed, broken, chopped, or cut into a final product for packaging and sale. A coating containing a flavoring is preferably basted onto the surface of the dried product, usually after the extrusion process is completed, although it is also within the scope of the invention to add a flavoring to the rawhide mixture prior to extrusion.

While it is preferred that the one or more nutraceutical agent be added to the rawhide mixture prior to extrusion, it is also possible to include a nutraceutical agent in the coating that is basted onto dried product.

Other extrusion methods exist that are suitable to manufacture the pet chew. For example, in other known rawhide extrusion processes the initial step of drying the wet rawhide scraps is not required and binders are not used, as is taught in U.S. Pat. No. 5,635,237, which is incorporated herein by reference in its entirety.

Other suitable mechanical manufacturing methods for the pet chew includes grinding the rawhide, nutraceutical agent(s), and any additives and pressing the ground mixture into a shape similar to a hamburger patty, or various other shapes. The pet chew can also be manufactured using injection molding.

Regardless of manufacturing method, the finished pet chew can comprise a roughly cylindrical shape with a diameter D and a length L defining the dimensions of the pet chew. By way of example, and without limitation, the dimensions of the pet chew can be 0.394″D×2.0″L, 0.787′D×2.0″L, or 0.787″D×3.0″L. The pet chew can also be bone-shaped, spherical, elliptical, rectangular, square, or any other desired shape.

According to one preferred embodiment of the invention, the pet chew comprises rawhide combined with EPA and DHA derived from marine sources, such as fish oil. The pet chew is preferably manufactured as described above, wherein the ground rawhide is mixed with fish oil, extruded, dried and basted with a flavoring to make the treats more palatable. The fish oil in the pet chew provides a source of the omega-3 fatty acids EPA and DHA and thus the pet chew is particularly useful for the management of the inflammation and pruritis associated with atopic dermatitis and dermatitis secondary to flea allergies in pets.

According to a second preferred embodiment of the invention, the pet chew comprises rawhide combined with one or more of the following nutraceutical agent(s): glucosamine, methylsulfonyl methane (MSM), creatine, perna canaliculus, and/or EPA and DHA derived from marine sources, such as fish oil. The pet chew is preferably manufactured as described above, wherein the ground rawhide is mixed with one or more of the above nutraceutical agents, extruded, dried and basted with beef flavoring to make the treats more palatable.

The nutraceutical agents listed above are common ingredients used in the management of osteoarthritis and thus the pet chew is particularly useful in the management of canine osteoarthritis or degenerative joint disease. Specifically, glucosamine is a small amino sugar which is one of the building blocks of articular cartilage. Supplementation in arthritic dogs helps to relieve the pain of arthritis and improve the condition of articular cartilage. Chondroitin (or chondroitin sulfate) is a structural component of cartilage and is a widely used dietary supplement for the treatment of osteoarthritis. MSM is a metabolite of dimethyl sulfoxide (DMSO) which is commonly used in veterinary medicine as an anti-inflammatory agent. MSM is thought to possess many of the qualities of its parent, DMSO, and is used in the management of canine arthritis as an anti-inflammatory and thus pain relieving compound. Pema canaliculus is used as a source of glycosaminoglycans (such as chondroitin) and omega-3 fatty acids. The glycosaminoglycans are building blocks of articular cartilage and act to relieve pain and promote cartilage integrity. The omega-3 fatty acids found in Perna canaliculus act to reduce inflammation associated with osteoarthritis and thus help to reduce pain. Creatine is present to help facilitate oxidative phosphorylation in muscle cells. This helps older arthritic pets to maintain muscle contraction ability and to continue to exercise. Fish oil is added to the pet chew to provide a source of EPA and DHA which helps to further reduce inflammation and pruritis.

The pet chew can comprise various proportions of rawhide, nutraceutical agent(s), and additives. Preferably, the pet chew comprises 50% to 75% by weight of rawhide; 5% to 20% by weight of fish oil and any other nutraceutical agent(s); 13% to 30% by weight of a binder, more preferably 10% to 20% of wheat flour and 3% to 10% of potato starch; 1% to 4% of a flavoring; and 0.01% to 1% of a coloring.

The nutraceutical agents can be added to the rawhide in various proportions depending on the recommended dosages to achieve a desired therapeutic treatment, that is, the nutraceutical agent is present in an effective amount. For example, for the first preferred embodiment of the invention, the amount of fish oil added to the rawhide can be in the range of 1% by weight to 10% by weight, preferably in the rage of 4% by weight to 5% by weight and most preferably about 4.5% by weight. These percentages will generally be in the range of 0.1 g to 2.0 g, preferably in the range of 0.5 g to 1.0 g and most preferably about 0.75 g based on a dog chew in the size ranges set forth above. Typically, the weight percent of the fish oil is in the range of about 4.-5 percent in a typical dog chew. For the second preferred embodiment of the invention, glucosamine can be added to the rawhide in the range of 2% to 7% by weight or 200 to 900 mg; chondroitin can be added to the rawhide in the range of 3% to 9% by weight; methylsulfonyl methane (MSM) can be added to the rawhide in the range of 2% to 7% by weight or 150 to 800 mg; creatine can be added to the rawhide in the range of 1% to 4% by weight or 100 to 500 mg; perna canaliculus can be added to the rawhide in the range of 0.5% to 3% by weight or 50 to 300 mg; fish oil can be added to the rawhide in the range of 0.02% to 1% by weight or 0.01 g to 1 g; all based on the dog chew in the size ranges set forth above.

According to a third preferred embodiment of the invention, the pet chew is hypoallergenic. The pet chew can be made according to any of the embodiments discussed above, however, the chew does not contain any ingredients in amounts effective to induce an allergic response in the pet. Examples of such allergy-causing ingredients include, but are not limited to, meat, wheat, and dairy products. Using the embodiments given above as examples, rawhide is replaced with hypoallergenic ingredients, such as soy and/or rice flour. Preferably the pet chew according to the third embodiment comprises both soy and rice flour, which serves as the binder when forming the pet chew by extrusion. The pet chew can comprise various proportions of soy and rice flour, nutraceutical agent(s), and additives. Preferably, the pet chew comprises 50% to 75% by weight of a mixture of soy and rice flour; 5% to 20% by weight of fish oil and any other nutraceutical agent(s); 13% to 30% by weight of a binder; 1% to 4% of a flavoring; and 0.01% to 1% of a coloring.

The pet chew of the present invention is unique because of the combination of nutraceutical agents in a palatable rawhide delivery vehicle. Rawhide is a substance which domestic animals such as dogs naturally enjoy chewing, which will encourage them to take the treat. The incorporation of fish oil alone or in combination with other nutraceutical agents into the pet chew imparts a heath benefit to the pet chew and delivers nutraceutical agents to create a composition that will help in the management of a specific condition or a symptom of a disease, such as inflammation, pain, flea allergies, and osteoarthritis. The pet chew is easy to manufacture using existing extrusion technology and incorporates the nutraceutical agent(s) into the pet chew during the extrusion process.

The following compositions are given by way of example of various embodiments of the invention, and is not intended to limit the present invention, but is given for illustrative purposes.

### EXAMPLE 1

A pet chew comprises the following ingredients, where the percentages given are the weight percent of the ingredient with respect to the total weight of all ingredients: 65% rawhide; 8% fish oil; 15% wheat flour; 6% potato starch; 5% beef liver flavoring; and 1% coloring.

The ingredients are extruded using the extrusion process described above. Specifically, the rawhide is mixed with the fish oil, wheat flour, and potato starch to form a homogeneous mixture. The coloring is also added to the rawhide mixture at this point. The rawhide mixture is then fed through the extruder and formed into a roughly cylindrical shape and is cut into lengths. The beef liver flavoring is basted onto the surface of the final, dried product. The final product has a diameter of 0.394 inches and a length of 2.0 inches.

The pet chew thus produced has 180 mg EPA, which is an effective amount of EPA for the management of the inflammation and pruritis associated with atopic dermatitis and dermatitis secondary to flea allergies in pets.

### EXAMPLE 2

A pet chew is made in accordance with Example 1 except that the amount of fish oil is reduced to 1% and 7% of glucosamine is added. The pet chew thus produced has an effective amount of fish oil and glucosamine to relieve the pain of arthritis and improve the condition of articular cartilage in dogs.

### EXAMPLE 3

A pet chew comprises the following ingredients, where the percentages given are the weight percent of the ingredient with respect to the total weight of all ingredients: 45.01% rice flour, 24.45% soy flour, 20% sugar, 1.5% salt, 2% hypoallergenic flavoring blend, 1% smoke flavor (such as Charsol® from Red Arrow Products Co., Manitowoc, Wis.), 0.02% garlic flavor, 0.01% sodium benzoate, 0.01% red coloring, and 6% fish oil.

The ingredients are extruded using the extrusion process described above. Specifically, the rice flour, soy flour, sugar, salt, smoke flavor, garlic flavor, sodium bezonate, red coloring, and fish oil are mixed together to form a homogeneous mixture. The mixture is then fed through the extruder and formed into a roughly cylindrical shape and is cut into lengths. The hypoallergenic flavoring is basted onto the surface of the final, dried product.

The pet chew thus produced has an effective amount of fish oil for the management of the inflammation and pruritis associated with atopic dermatitis and dermatitis secondary to flea allergies in pets.

### EXAMPLE 4

A pet chew comprises the following ingredients, where the percentages given are the weight percent of the ingredient with respect to the total weight of all ingredients: 22.2% soy flour, 42.18% rice flour, 19.38% sugar, 1.48% salt, 0.89% smoke flavor (such as Charsol® from Red Arrow Products Co., Manitowoc, Wis.), 0.01% sodium benzoate, 0.01% red coloring, 2% hypoallergenic flavoring blend, 0.89% fish oil, and 10.36% glucosamine/chondroitin mixture.

The ingredients are extruded using the extrusion process described above. Specifically, the soy flour, rice flour, sugar, salt, smoke flavor, sodium bezonate, red coloring, fish oil, and the glucosamine/chondroitin mixture are mixed together to form a homogeneous mixture. The mixture is then fed through the extruder and formed into a roughly cylindrical shape and is cut into lengths. The hypoallergenic flavoring is basted onto the surface of the final, dried product.

The pet chew thus produced has an effective amount of fish oil and glucosamine to relieve the pain of arthritis and improve the condition of articular cartilage in dogs.

While the invention has been specifically described in connection with certain specific embodiments thereof, it is to be understood that this description is by way of illustration and not of limitation. Reasonable variation and modification are possible within the scope of the forgoing disclosure without departing from the spirit of the invention which is defined in the appended claims.

What is claimed is:

1. A pet chew comprising a tough, chewable substrate in a form that is adapted to be chewed or ingested by a domestic animal combined with an effective amount of a nutraceutical agent that includes fish oil.

2. The pet chew according to claim 1 wherein the fish oil is present in an amount ranging from 1 to 10% by weight of the pet chew.

3. The pet chew according to claim 2 wherein the fish oil is present in an amount ranging from 4% to 5% by weight of the pet chew.

4. The pet chew according to claim 3 wherein the fish oil comprises of 4.5% by weight of the pet chew.

4. The pet chew according to claim 1 and further comprising a second nutraceutical agent.

5. The pet chew according to claim 4 wherein the second nutraceutical agent is selected from the group consisting of glucosamine hydrochloride, glucosamine sulfate, glucosamine potassium, glucosamine sodium, N-acetyl d-glucosamine, methyl sulfonlymethane (MSM), dimethyl sulfoxide (DMSO), chondroitin, perna canaliculus or green lipped mussel (New Zealand Green Lipped mussel), creatine, omega-3 fatty acids derived from marine sources, vitamin C, vitamin D, vitamin E, vitamin K, Alpha Lipoic Acid, grape seed extract, grape seed meal, dimethyl glycine, whey protein, manganese, manganese proteinate, zinc, zinc proteinate, copper, copper proteinate, brewer's yeast, St. John's wort, ginseng, green tea, ginger, garlic, vincamine, vinpocetine, aloe vera, ginko biloba and any combination thereof.

6. The pet chew according to claim 4 wherein the second nutraceutical agent is present in an amount ranging from 0 to 20% by weight of the pet chew.

7. The pet chew according to of claim 6 wherein the second nutraceutical agent comprises at least one of glucosamine in the range of 2 to 7% by weight of the pet chew; chondroitin in the range of about 3 to 9% by weight of the pet chew; methylsulfonyl methane in the range of 2 to 7% by weight of the pet chew; creatine in the range of 1 to 4% by weight of the pet chew; and perna canaliculus in the range of 0.5 to 3% by weight of the pet chew.

8. The pet chew according to claim 4 and further comprising at least one of glucosamine, chondroitin, methylsulfonyl methane, creatine, and perna canaliculus as nutraceutical agents.

9. The pet chew according to claim 1 wherein the substrate comprises rawhide.

10. The pet chew according to of claim 9 wherein the substrate comprises at least 50% rawhide by weight of the pet chew.

11. The pet chew according to claim 1 wherein the pet chew is free of meat, wheat, and dairy products.

12. The pet chew according to claim 1 wherein the substrate is hypoallergenic.

13. The pet chew according to claim 12 wherein the substrate comprises at least one of rice and soy.

14. The pet chew according to claim 13 wherein the at least one of rice and soy are in the form of flour.

15. The pet chew according to claim 14 wherein the substrate comprises both rice flour and soy flour.

16. The pet chew according to claim 13 wherein the substrate comprises at least 50% of the at least one of rice and soy by weight of the pet chew.

17. The pet chew according to claim 1 wherein the pet chew is formed by extrusion.

18. The pet chew according to claim 17 wherein a substrate ingredient is comminuted into small particles, mixed with the fish oil and a binder, and then extruded into a form suitable for chewing by a domestic animal.

19. The pet chew according to claim 17 wherein the fish oil is present on the substrate in the form of a coating.

20. The pet chew according to claim 1 wherein the substrate is rawhide in an amount of about 65% by weight, the fish oil is present in an amount of about 8% by weight, and further comprising about 15% wheat flour by weight and 6% potato starch by weight.

21. The pet chew according to claim 1 wherein the substrate is rawhide in an amount of about 65% by weight, the fish oil is present in an amount of about 1% by weight, the nutraceutical agent further includes about 7% glucosamine by weight and further comprising about 15% wheat flour by weight and 6% potato starch by weight.

22. The pet chew according to claim 1 wherein the substrate comprises about 45% rice flour by weight, about 24% soy flour, 20% sugar, and the fish oil is present in about 6% by weight.

23. The pet chew according to claim 1 wherein the substrate comprises about 22% soy flour by weight, about 42% rice flour by weight, about 20% sugar by weight, and the fish oil is present in about 1% by weight, and the nutraceutical agent further includes about 10% of a glucosamine/chondroitin mixture by weight.
